(19) United States
(12) Patent Application Publication
(10) Pub. No.: US 2020/0326521 A1
(43) Pub. Date: Oct. 15, 2020

(54) MICROSCOPE WITH OVERSIZED ZOOM SYSTEM

(71) Applicant: LEICA MICROSYSTEMS (SCHWEIZ) AG, Heerbrugg (CH)

(72) Inventors: Harald SCHNITZLER, Lüchingen (CH); Rouven HEEB, Gams (CH)

(21) Appl. No.: 16/914,308

(22) Filed: Jun. 27, 2020

Related U.S. Application Data
(62) Division of application No. 15/516,447, filed on Apr. 3, 2017.

(30) Foreign Application Priority Data
Oct. 6, 2014 (DE) 10 2014 114 467.8

(51) Int. Cl. G02B 21/02; G02B 21/36; G02B 15/16

(52) U.S. Cl. CPC G02B 21/025; G02B 15/16; G02B 21/361

(57) ABSTRACT

The invention relates to a microscope (10) that encompasses an objective system (30) having at least two objectives (44, 52) selectably introducible into the beam path of the microscope (10), and a zoom system (32). The zoom system (32) has a total zoom range (90) within which the focal length of the zoom system (32) is settable. A zoom sub-range (96, 98) within the total zoom range (90) is allocated to each of the objectives (44, 52).

### CROSS-REFERENCE TO RELATED APPLICATIONS

The present application is a division of U.S. application Ser. No. 15/516,447 filed Apr. 3, 2017, which is the U.S. national phase of International Application No. PCT/EP2015/072657 filed Oct. 1, 2015, and claims priority of German Application No. 10 2014 114 467.8 filed Oct. 6, 2014, the entire disclosure of which is incorporated herein by reference.

### FIELD OF THE INVENTION

The invention relates to a microscope that comprises an objective system as well as a zoom system having a total zoom range. The objective system encompasses at least two objectives, selectably introducible into the beam path, having different focal lengths. The total magnification of an object to be examined microscopically results in this context from the focal length of the selected objective and from the zoom system focal length that is set.

### BACKGROUND OF THE INVENTION

Magnification systems that comprise both an objective system and a zoom system are often used in digital microscopes, the zoom system imaging the image of the object to be examined microscopically directly onto an image capture unit of the digital microscope system. The magnification that results here is the quotient of the zoom system focal length that is set, and the focal length of the objective located in the beam path. In order to achieve the highest possible magnification, a maximum focal length must be set in the zoom system, and an objective having a short focal length must be used. Conversely, for a low magnification the shortest possible focal length must be set via the zoom system, and an objective having the longest possible focal length must be used.

In known microscopes a maximum zoom factor, i.e. a widest possible settable magnification range, is achieved by the fact that the zoom range is utilized out to its respective limits and objectives having very different focal lengths are correspondingly used. The maximum and minimum magnification are thus set by adapting the objectives to the zoom system.

In order to achieve the widest possible magnification range, both objectives having a very short focal length and objectives having a very long focal length must therefore be used. Objectives having very short focal lengths are disadvantageous, however, because the numerical apertures necessary for high magnifications require objectives of complex design. Such objectives then usually allow only very narrow field angles, since otherwise the optical corrections cannot be obtained. High-aperture compound objectives therefore generally do not allow addition of a downstream zoom system, and cut off wider field angles due to vignetting.

Conversely, the long objective focal lengths necessary for low magnifications require a correspondingly long distance between the objective interface and the object plane. Upon introduction of such objectives into the beam path it is therefore usually necessary to move the zoom system away from the object in order to obtain the requisite long distance from the object plane. A further disadvantage of objectives having long focal lengths is that the pupil diameter must be correspondingly large for a given object-side resolution; this results in high costs and large dimensions for the objectives.

The use of objectives having very different focal lengths furthermore has the disadvantage that the objectives also have very different equalization lengths, the equalization length being the distance from the shoulder of the objective to the object plane and being made up of the overall length of the objective and the clear working distance. This makes parfocal configuration of the system very difficult or even impossible.

### SUMMARY OF THE INVENTION

The object of the invention is to describe a microscope that exhibits a wide magnification range and is nevertheless of simple and compact configuration.

This object is achieved by a microscope having the features described herein. Advantageous refinements of the invention are also described herein.

According to the present invention, a first zoom sub-range within the total zoom range is allocated at least to a first objective.

The result of using a zoom system that is dimensioned to be larger than would actually be necessary for the desired zoom factor is that the differences in the focal lengths of the objectives that are used do not need to be so great as in conventional microscopes. What can be achieved in particular by allocating zoom sub-ranges is that with high-magnification objectives a high total magnification is also produced by the zoom system, and this thus interacts for a maximally high magnification. With low-magnification objectives, on the other hand, the zoom sub-range within the total zoom range is selected in such a way that it also corresponds to a lower magnification, so that wide field angles are achieved. The result of the allocated zoom sub-range is thus that the zoom system is respectively adapted to the individual requirements of the respective objective, so that less stringent requirements can correspondingly be applied to the construction of the objectives and, in particular, objectives having focal lengths more closely adjacent to one another can be used. The result of this is that the objectives can be constructed to be more compact and thus more inexpensive. In particular, objectives having more similar dimensions can thereby be used, in particular enabling a parfocal objective system. The result of such a parfocal embodiment of the objective system is in turn that refocusing is not necessary upon an objective change. It furthermore becomes possible to achieve a comparatively large zoom factor. The accompanying advantage is that, in particular, what results for the operator is a zoom factor that in fact remains the same for each objective.

The “total zoom range” of the zoom system is understood in particular as the physically constrained maximum available zoom range. The total zoom range indicates in particular the various focal lengths over which the zoom system can be adjusted. The limits of the total zoom range are thus defined by a minimum focal length and a maximum focal length of the zoom system.

The objective system encompasses in particular an objective turret in which the various objectives are mounted, and by rotation of which the respectively desired objective can be introduced into the beam path. The objectives themselves are embodied in particular in such a way that the respective mutual arrangement therein of the individual lens groups is permanently defined and not adjustable. The zoom system, conversely, comprises several lens groups of which at least one is axially movable relative to the immovable lens groups, with the result that the focal length of the zoom system, and thus its magnification, can be adjusted.

Preferably a second zoom sub-range within the total zoom range is also allocated to the second objective.

In a preferred embodiment the zoom sub-range of at least one objective is narrower than the total zoom range. It is particularly advantageous if the zoom sub-ranges of all the objectives are respectively narrower than the total zoom range of the zoom system. For each objective, only that respective sub-range of the total zoom range which matches, in terms of its properties, the properties of the objective is then respectively used for each objective.

Because the total zoom range of the objective is thus wider than the zoom sub-ranges that are used for the individual objectives, the zoom system is also referred to as “overdimensioned” or “oversized.”

The zoom sub-ranges of the objectives can also at least partly overlap. Alternatively, it is also possible for the zoom sub-ranges to be selected in such a way that no overlaps occur. The result of the overlap of the zoom ranges is that each objective has a maximally wide adjustment range thanks to the corresponding setting of the focal length of the zoom system, and the magnification can be correspondingly widely varied.

In a preferred embodiment of the invention, the upper and lower limits of the zoom sub-ranges are each selected in such a way that in the various zoom sub-ranges the same predetermined zoom factor is obtained in each case between the respective lower and upper limit. The “zoom factor” is understood in particular as the quotient of the upper and the lower limit, i.e. in particular the quotient of the maximum focal length and minimum focal length, for the respective zoom sub-range. The result thereby achieved is that the same zoom factor is available to the operator for each objective, so that the operator has the same magnification capability regardless of which objective he or she is using, although different total magnifications will of course result depending on the objective used, since they result from the quotient of the focal length of the zoom system divided by the focal length of the objective.

It is advantageous in particular if the lower limit of at least one zoom sub-range corresponds to the lower limit of the total zoom range, and the upper limit of at least one zoom sub-range corresponds to the upper limit of the total zoom range. What is achieved thereby is that the total zoom range of the zoom system is optimally utilized, and that the resulting total zoom factor of the microscope is also as large as possible.

It is particularly advantageous if the zoom sub-ranges are preset in such a way that the zoom sub-range of an objective having a focal length that is longer than the focal length of another objective encompasses magnifications or focal lengths that are lower or shorter than the lowest magnification or shortest focal length of the zoom sub-range of that other objective. If the one objective has a longer focal length than the other objective, this means that that objective produces a lower magnification than the other objective. The zoom sub-range is thus selected in such a way that, referred to the total zoom range, it covers the shorter focal lengths of the zoom sub-range, so that the properties of the objective and of the zoom system, in particular the desired wide field angle at low magnifications, optimally complement one another.

Conversely, the zoom sub-ranges are preset in such a way that the zoom sub-range of an objective having a focal length that is shorter than the focal length of another objective encompasses magnifications or focal lengths that are higher or longer than the highest magnification or longest focal length of the zoom sub-range of another objective. The result thereby achieved is that for objectives having a high magnification, the zoom sub-range also covers the long focal lengths of the total zoom range and thus contributes to a higher total magnification.

In a particularly preferred embodiment of the invention, the objective system has a first objective having a first focal length and a second objective having a second focal length, the second focal length being longer than the first focal length. The second objective thus results in a lower magnification than the first objective. The total zoom range has a third focal length as a lower limit and a fourth focal length as an upper limit. The first zoom sub-range allocated to the first objective has the fourth focal length as an upper limit, and the second zoom sub-range allocated to the second objective has the third focal length as a lower limit. The result thereby achieved is that the first objective, which has the higher magnification of the two objectives, achieves a maximum total magnification when the fourth focal length is set together with the zoom system. Conversely, a minimum magnification can be achieved by selecting the second objective and the third focal length.

The focal lengths can also be selected, in particular, in such a way that with corresponding settings, the total magnifications that result are less than 1, i.e. objects are imaged smaller.

It is furthermore advantageous if limiting means are provided, with which the adjustability of the zoom system is respectively limited to the zoom sub-range that is allocated to the selected objective, i.e. to the objective that is currently introduced into the beam path.

In a particularly preferred embodiment of the invention, at least one stop is provided as a limiting means on each objective, the adjustability of the zoom system being limited by the stop to the zoom sub-range respectively allocated to that objective. The result is, in particular, to ensure in entirely mechanical fashion that for each objective, an adjustment of the zoom system is possible only within the allocated zoom sub-range.

In a particularly preferred embodiment, two stops, by which the adjustment of the zoom system is limited, are provided on each objective. If one limit of the zoom sub-range is defined by a limit of the physically constrained maximum possible total zoom range, a stop can be omitted at that end.

In a particularly preferred embodiment of the invention the adjustment of the zoom system can also be accomplished electrically, by the fact that an electric drive unit, in particular a motor, is provided. A control unit for applying control to the drive unit is also provided, the sub-ranges allocated to the respective objectives being stored in that control unit. The control unit then applies control to the drive unit in such a way that an adjustment is possible in each case only within the respective zoom sub-range. In particular, a sensor suite is provided, with which the control unit can automatically detect which objective is introduced into the beam path, so that the control unit then automatically selects the zoom sub-range settable by the operator and correspondingly applies control to the electric drive unit. In this case it is possible in particular to omit mechanical stops for limiting the zoom sub-range, since the application of control to the electric drive unit serves as a limiting means.

It is furthermore advantageous if the microscope encompasses an actuation element for manually setting the magnification factor of the zoom system. This actuation element can be a rotary knob.

It is furthermore advantageous if the microscope encompasses a diaphragm for setting the light transmittance as a function of the respectively selected objective and of the respectively set focal length of the zoom system. This diaphragm is, in particular, a controlled iris diaphragm that regulates the aperture profile as a function of the objective and of the zoom system focal length that is set. This is necessary in particular because of the generally smaller pupil diameters in the context of high-magnification objectives. With high-magnification objectives the magnification typically rises more steeply than the aperture, since otherwise the aperture ratio of the objective becomes too great so that aberration correction would be very complex. In an alternative embodiment, such a diaphragm can be omitted if corresponding objectives having very large apertures are used.

It is furthermore advantageous if the zoom system comprises at least two lens groups, one of which is movable in the direction of the optical axis in order to set the focal length of the zoom system. In a preferred embodiment the zoom system comprises three or four lens groups, two of which are movable in the direction of the optical axis.

The microscope is, in particular, a digital microscope that encompasses an image capture unit for acquiring images of the object to be examined microscopically. In the digital microscope, the image of the object to be examined microscopically is, in particular, imaged via the zoom system directly onto the image capture unit.

An alternative embodiment can also involve visual microscopy.

### BRIEF DESCRIPTION OF THE DRAWING VIEWS

Further features and advantages of the invention are evident from the description below, which explains the invention in more detail with reference to exemplifying embodiments in conjunction with the attached Figures, in which:

FIG. 1 is a schematic perspective depiction of a digital microscope;

FIG. 2 schematically depicts a magnification system of the microscope according to FIG. 1;

FIG. 3 schematically depicts a magnification system according to FIG. 2 when a first objective is in use;

FIG. 4 schematically depicts a magnification system according to FIG. 2 when a second objective is in use;

FIG. 5 schematically depicts a total zoom range and the zoom sub-ranges of the first and the second objective;

FIG. 6 is a schematic perspective depiction of a portion of the microscope according to FIG. 1;

FIG. 7 is a further schematic perspective depiction of the portion according to FIG. 6;

FIG. 8 schematically depicts a housing of the microscope;

FIG. 9 is a further schematic perspective depiction of the housing according to FIG. 8;

FIG. 10 schematically depicts a detail of the microscope;

FIG. 11 schematically depicts a portion of an objective and of an objective housing;

FIG. 12 is a schematic perspective depiction of the actuation element of the zoom system in a first rotational position;

FIG. 13 is a schematic perspective depiction of the actuation element according to FIG. 12 in a second rotational position;

FIG. 14 schematically depicts the actuation element with a first objective inserted, in a first operating state;

FIG. 15 schematically depicts the actuation element with a first objective inserted, in a second operating state;

FIG. 16 schematically depicts the actuation element with a second objective inserted, in a third operating state;

FIG. 17 schematically depicts the actuation element with a second objective inserted, in a fourth operating state;

FIG. 18 schematically depicts the actuation element with a third objective inserted, in a fifth operating state; and

FIG. 19 schematically depicts the actuation element with a third objective inserted, in a sixth operating state.

### DETAILED DESCRIPTION OF THE INVENTION

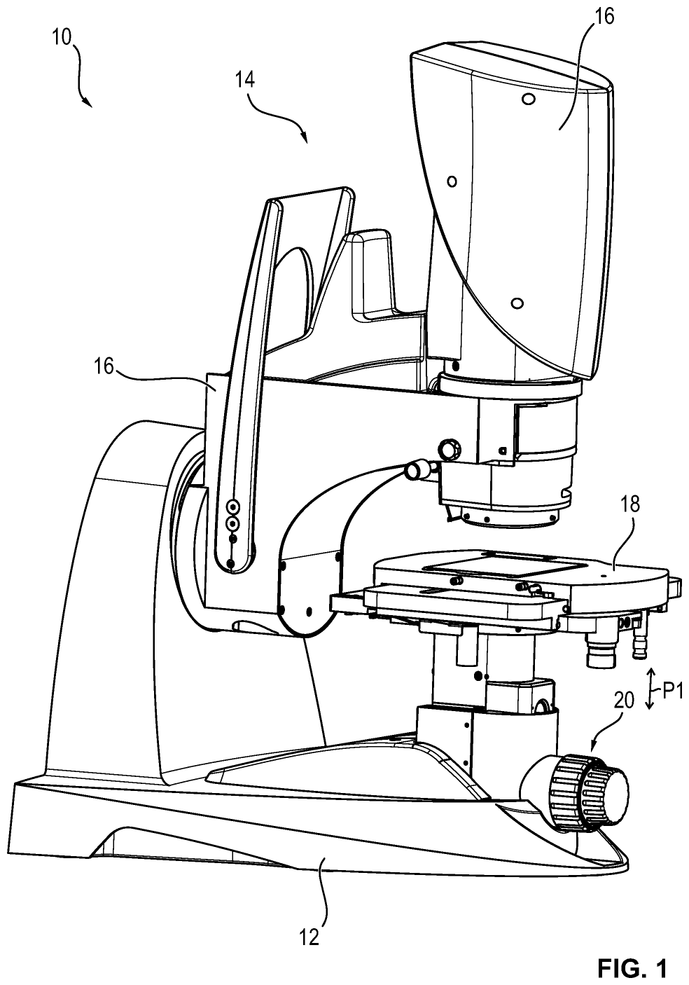

FIG. 1 is a schematic perspective depiction of a digital microscope. Microscope 10 encompasses a stationary stand body 12 as well as a pivoting unit 14 pivotable relative thereto.

Pivoting unit 14 encompasses at least one image capture unit with which an image of the objects to be examined microscopically can be acquired. In particular, by way of this image capture unit not only individual images but also videos can be acquired, making it possible to observe the object to be examined microscopically from different angles of view.

The pivoting unit furthermore comprises an objective and a zoom system with which different magnifications of the objects to be examined microscopically can be set. The objective system has a plurality of objectives, one of which is introduced respectively into the beam path.

The image capture unit, the objective system, and the zoom system are not visible in FIG. 1, since they are concealed by housing 16 of pivoting unit 14.

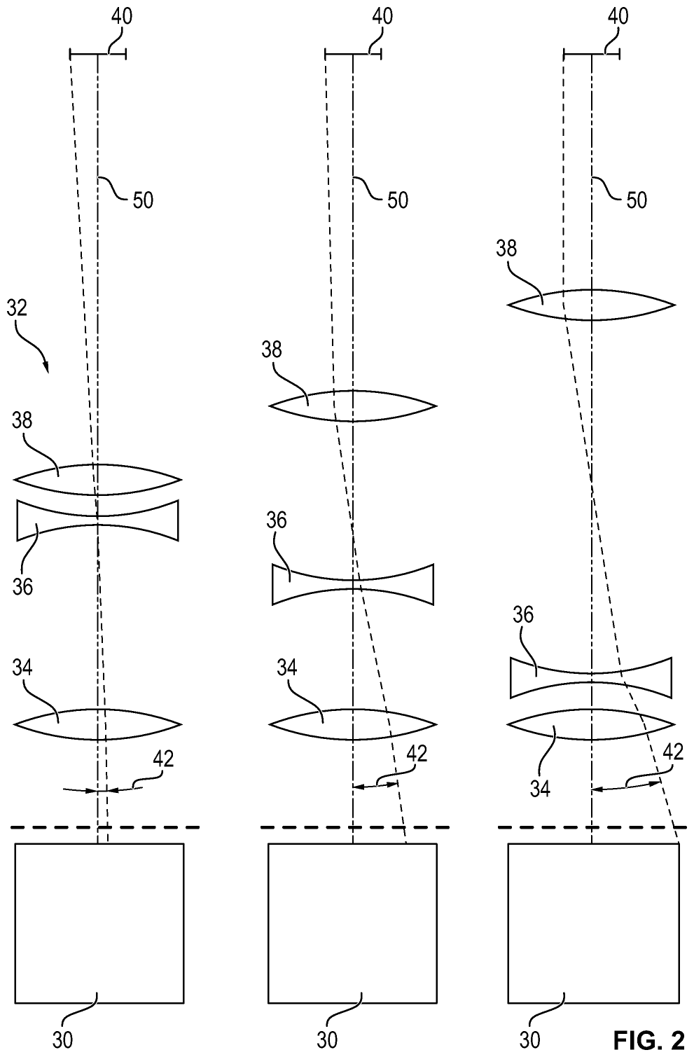

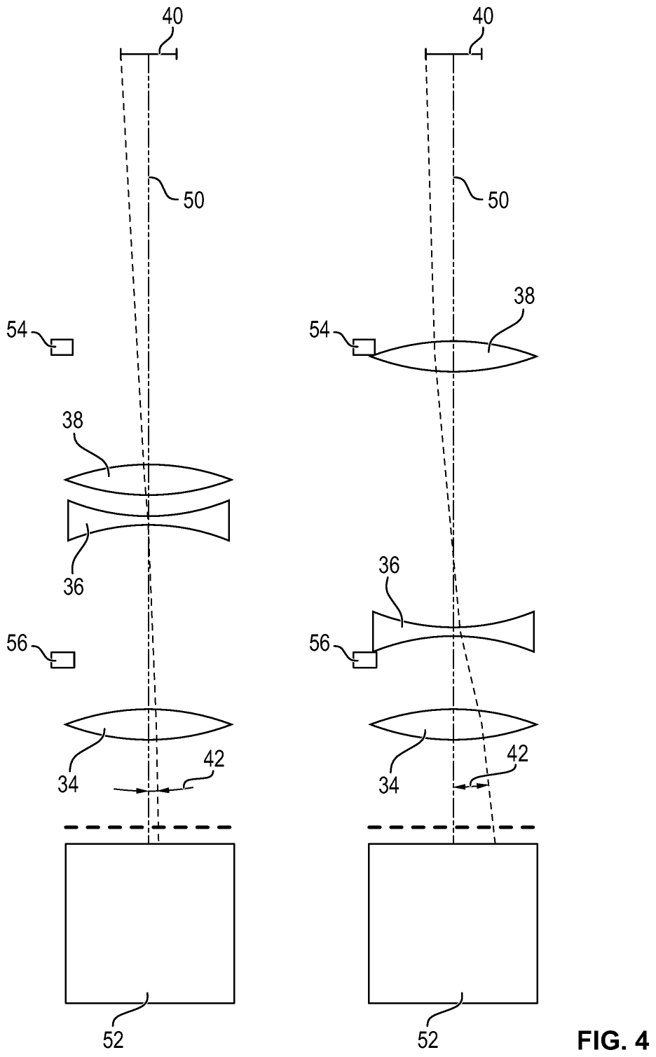

The construction of the objective system and of the zoom system will be described in further detail below in conjunction with FIGS. 2 and 4.

The objectives of the objective system are embodied, in particular, parfocally, so that no refocusing needs to be performed by the operator upon an objective change. The objectives are matched in particular to the distance between the rotation axis, around which pivoting unit 14 can be rotated, and the interface of the objectives, thus yielding a eucentric system the consequence of which is that refocusing does not need to occur upon pivoting of pivoting unit 14.

Also arranged on the stand body is a specimen stage 18 on which the objects to be examined microscopically are mounted. This specimen stage 18 can be adjusted, with the aid of positioning wheels 20, relative to stand body 12 in the direction of double arrow P1, thus allowing focusing of the objects to be examined microscopically.

FIG. 2 shows, entirely schematically, the magnification system arranged in pivoting unit 14 in three different settings. The magnification system encompasses an objective system 30 as well as a zoom system 32, the interaction of which causes the desired total magnification to be achieved. Objective system 30 encompasses at least two objectives 44, 52 having different focal lengths, one of which is respectively pivoted selectably into the beam path of microscope 10.

Zoom system 32 comprises three lens groups 34 to 38, two lens groups 36, 38 of which are adjustable in the direction of optical axis 50. In an alternative embodiment of the invention the zoom system can also encompass only two lens groups 34 to 38, only one lens group 34 to 38 of which is axially adjustable. Zoom systems having more than three lens groups 34 to 38 are also conceivable.

In the embodiment shown in FIG. 2, the image of the object is imaged via zoom system 32 directly onto an image capture unit 40 that can be, in particular, a camera.

FIG. 2 shows three settings of zoom system 32. In the left setting, zoom system 32 is set so that it has a maximum focal length and thus produces a maximum magnification. Field angle 42, which indicates the angle of the main beam with respect to optical axis 50 in the region of the interface to objective system 30, is correspondingly minimal.

The right setting depicted in FIG. 2, conversely, shows the other extreme setting of zoom system 32, namely the setting in which zoom system 32 has a minimum focal length and correspondingly produces a minimum magnification effect. In this case field angle 42 is maximal.

The middle case shown in FIG. 2 represents an intermediate position in which zoom system 32 achieves a focal length that is longer than the minimum focal length and shorter than the maximum focal length. Field angle 42 is correspondingly between field angles 42 of the other two cases.

The respective total magnification of microscope 10 results from the quotient of the focal length set for zoom system 32, and the focal length of that objective 44, 52 of objective system 30 which is introduced into the beam path.

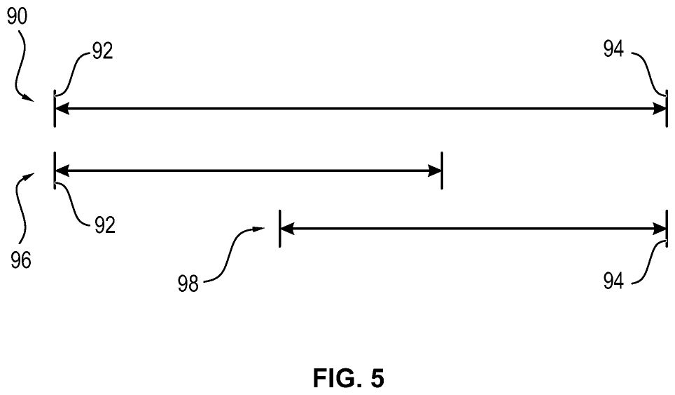

Zoom system 32 has a total zoom range that indicates which focal lengths of zoom system 32 can be set via zoom system 32. This total zoom range is depicted in FIG. 5, by way of example, by arrow 90; lower limit 92 indicates the minimum focal length of zoom system 32 that is produced for the setting shown on the right in FIG. 2. Upper limit 94 of total zoom range 90 correspondingly indicates the maximum focal length of zoom system 32 which is produced for the setting shown on the left in FIG. 2. Total zoom range 90 is thus predefined, in particular, in physically constrained fashion, and indicates the maximum possible range of magnifications of zoom system 32.

As already described, objective system 32 encompasses several objectives 44, 52 having different focal lengths. A zoom sub-range within total zoom range 90 is allocated to each of these objectives 44, 52, a first zoom sub-range 96 for a first objective 44 and a second zoom sub-range 98 of a second objective 52 being depicted in FIG. 5. The two zoom sub-ranges 96, 98 each cover only a portion of total zoom range 90, and in particular are configured in such a way that they at least partly overlap.

Microscope 10 is embodied in such a way that zoom system 32 is always adjustable only within the respective zoom sub-range 96, 98 that is allocated to objective 44, 52 currently pivoted into the beam path.

In the exemplifying embodiment depicted in FIG. 5, first objective 44 to which zoom sub-range 96 is allocated has a longer focal length compared with second objective 52, and thus a lesser magnification effect. First zoom sub-range 96 is correspondingly also selected in such a way that it covers the lower magnifications of total zoom range 90 as compared with second zoom sub-range 98, whereas second zoom sub-range 98 encompasses the higher magnifications of total zoom range 90.

The result thereby achieved is that for objectives 52 having a high magnification, i.e. a short focal length, high magnifications are also achieved by the zoom system, so that a high total magnification is achieved overall.

Conversely, with objectives 44 of low magnification, i.e. having a wide field angle, zoom sub-range 96, for which range zoom system 32 again has low magnification and thus a wide field angle, is allocated.

The sub-range of zoom system 32 which is used is thus always matched to the properties of the respective objective 44, 52.

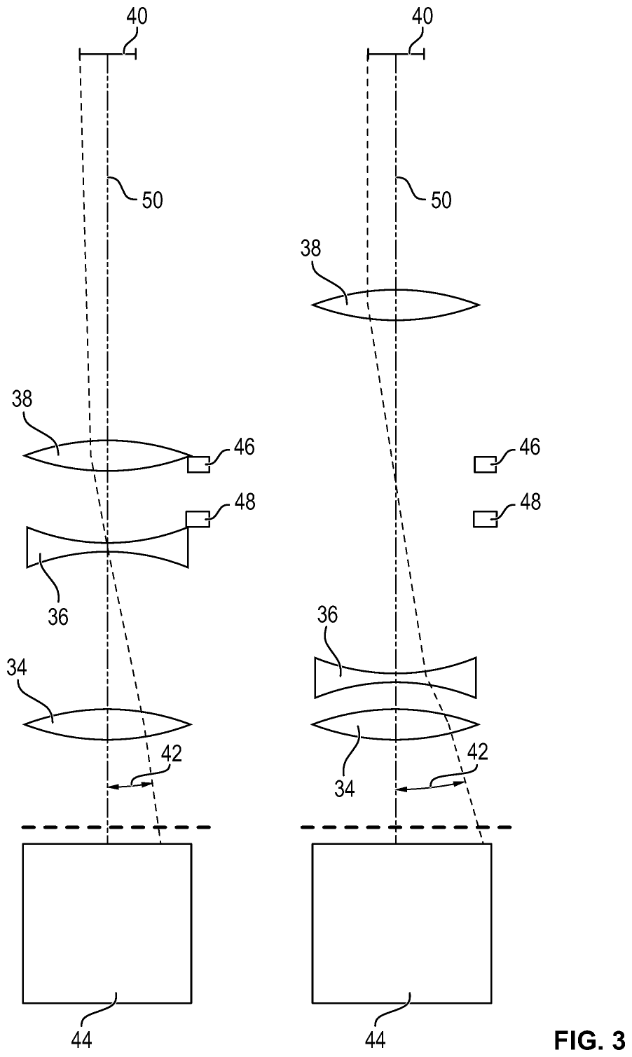

FIG. 3 schematically depicts the magnification system of FIG. 2 in two states, first objective 44 of objective system 30 being introduced into the beam path. With first objective 44, which has a relatively long focal length, i.e. low magnification, the adjustability of zoom system 32 is limited by limiting elements 46, 48 in such a way that, compared with the maximum adjustment range shown in FIG. 2, adjustment is possible down to the minimum focal length (FIG. 3, right) but not up to the maximum focal length. An adjustment of zoom system 32 is correspondingly possible only within first zoom sub-range 96. The movement of lens groups 36, 38 toward one another is limited, via limiting elements 46, 48, to the state shown on the left in FIG. 3. Limiting elements 46, 48 are, in particular, stops that are coupled to first objective 44, so that upon introduction of first objective 44 into the beam path, stops 46, 48 are also automatically moved so that they are arranged in such a way that they are arranged in the movement region of lens groups 34 to 38.

FIG. 4 shows the case in which second objective 52 is pivoted into the beam path. This objective 52 as well in turn encompasses stops 54, 56 with which the adjustment of zoom system 32 can be limited to second zoom sub-range 98. With this second objective 52, stops 54, 56 prevent lens groups 36, 38 from being moved farther apart from one another than the state shown on the right in FIG. 4, so that setting of the minimum magnification is prevented.

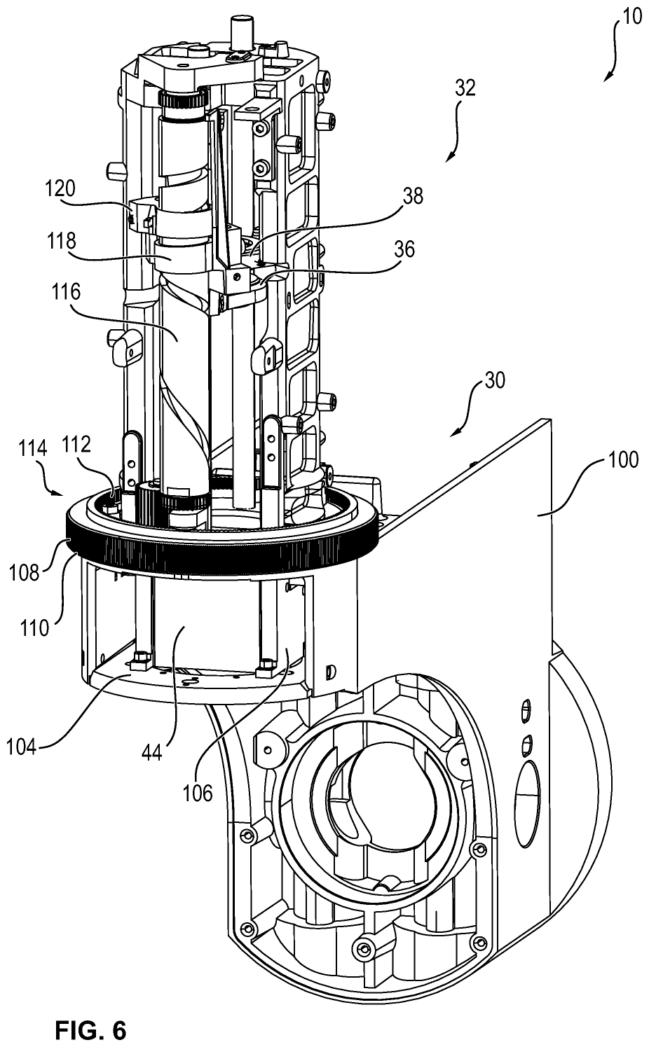

Limiting elements 46, 48, 54, 56 are depicted merely schematically in FIGS. 3 and 4. In the concrete embodiment as shown in FIGS. 6 to 19, limiting elements 46, 48, 54, 56 are arranged in particular not in zoom system 32 but instead, as will be explained below in detail, as adjustable pins 130 to 136 at the interface between objective system 30 and zoom system 32.

As depicted in FIG. 5, zoom sub-ranges 96, 98 in which zoom system 32 is respectively operated are thus configured to be narrower than the maximum zoom range 90, and for that reason zoom system 32 is also referred to as “overdimensioned” or “oversized.”

Compared with known microscopes in which the entire zoom range is always used, and the maximum and minimum magnification is brought about by corresponding selection of the objectives, the objectives that are used now no longer need to have such different focal lengths for the same total magnification range, as the following quantitative example is intended to illustrate:

In order to achieve a magnification range of between 0.15× and 30× with two objectives in a microscope according to the existing art, for example, a first objective having a focal length of 20 and a second objective having a focal length of 250 are used. The zoom system has an adjustable focal length of between 38 and 600. The maximum magnification of 30 is achieved by using the first objective and setting the maximum focal length of the zoom system. In this case a magnification of 30 is obtained using the calculation formula b=f zoom/f objective, therefore 600/20=30.

The minimum magnification of 0.15 is correspondingly obtained using the second objective and the minimum focal length of the zoom system, as the quotient of 38 and 250.

In order to achieve the same magnification range of 0.15× to 30× with the microscope according to the embodiment of the invention, a zoom system 32 having an adjustable focal length of between 21 and 600 is now used. The zoom sub-range of first objective 44 is 38 to 600; the zoom sub-range of the second objective is 21 to 336. First objective 44 has a focal length of 140; second objective 52 has a focal length of 20.

For a maximum magnification of 30, once again second objective 52 is used together with the maximum focal length of zoom system 32. For a minimum magnification, first objective 44 is used together with the minimum focal length of zoom system 32, once again yielding the factor 0.15 as the quotient of 21 and 140.

The same total magnification range can thus be achieved, but the resulting focal length difference between objectives 44, 52 that are used is considerably smaller.

This has the advantage that objectives 44, 52 can be substantially more compact and of simple construction. In particular, a parfocal objective system 30 can be realized by way of the smaller spread between the focal lengths of objectives 44, 52. A further result is that the zoom factor selectable by the operator is the same for each objective 44, 52, i.e. in the aforementioned example a zoom factor of 16 (336/21 and 600/38).

The allocation of zoom sub-ranges to different objectives can be used not only with digital microscopes but also, alternatively, with any other microscopes having an objective system and a zoom system.

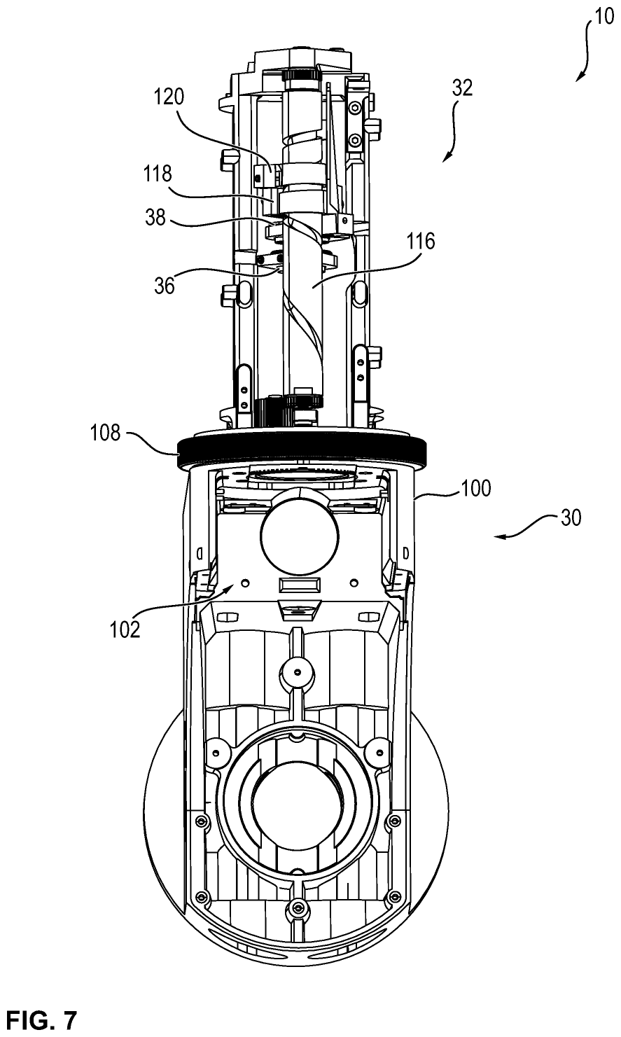

FIGS. 6 and 7 are respective schematic perspective depictions of a detail of microscope 10 of FIG. 1, depicting a portion of zoom system 32 and of objective system 30. The emphasis with respect to the depiction in FIGS. 6 and 7 and also the subsequent Figures is on explaining how the limitation of the adjustability of zoom system 32 to the respective zoom sub-ranges 96, 98 of the various objectives 44, 52 is accomplished entirely mechanically.

Objective system 30 comprises a housing 100 in which is provided a receiving region 102 in which the respective objective 44 currently introduced into the beam path is received. In the depiction of FIG. 7, no objective is received in this receiving region 102. In the depiction of FIG. 6, conversely, an objective 44 is slid into receiving region 102. Objective 44 is mounted here on a plate 104 and surrounded by a housing 106, and plate 104 can be fastened onto housing 100 of objective system 30.

Objective system 32 comprises a rotary wheel 108 that can be rotated by the operator of microscope 10. For better handling, knurling 110 is provided in particular on the peripheral surface of rotary wheel 108. Rotary wheel 108 has, on the side facing away from knurling 110, a tooth set 112 by way of which rotary wheel 108 is in engagement, with the aid of a gear system 114, with a spindle 116. Spindle 116 is correspondingly rotated by rotating rotary wheel 108.

Lens groups 36, 38 are mounted via holders 118, 120 on spindle 116. Lens groups 36, 38 are correspondingly moved toward or away from one another upon rotation of spindle 116.

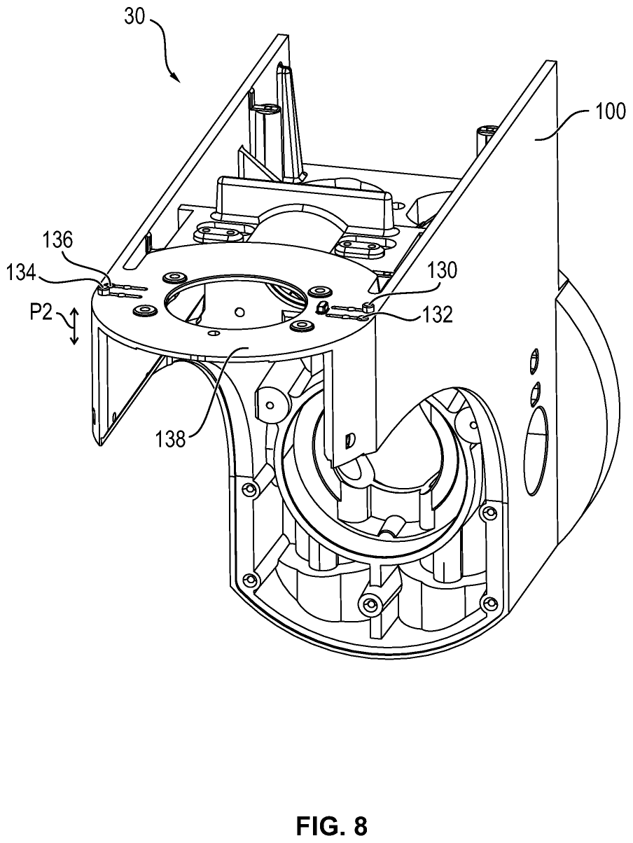

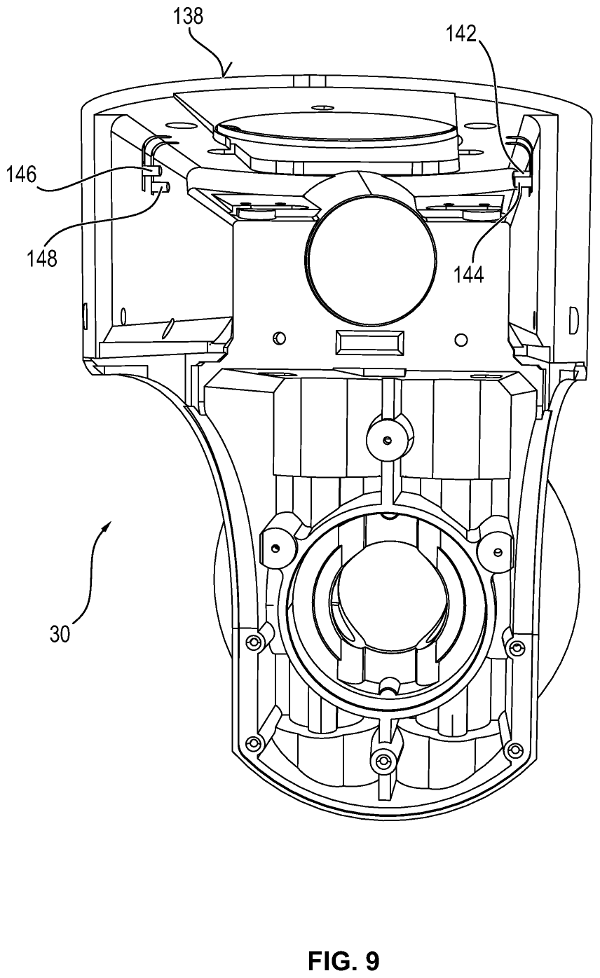

FIGS. 8 and 9 are respective schematic perspective depictions of housing 100 of objective system 30. A total of four pins 130 to 136 are arranged in housing 100, movably, in particular vertically, in the direction of double arrow P2. Pins 130 to 136 are movable between an activated or deactivated position; in the depiction of FIG. 8, pins 130, 134 are shown in the activated position and pins 132, 136 in the deactivated position. In the activated position, pins 130 to 136 project a predetermined distance out from surface 138 of housing 100 toward rotary wheel 108. In the deactivated position, pins 130 to 136 are arranged within housing 100 and, in particular, do not project out of it. Alternatively, they can also project slightly out of housing 100 in the deactivated position, but not as far as in the activated position.

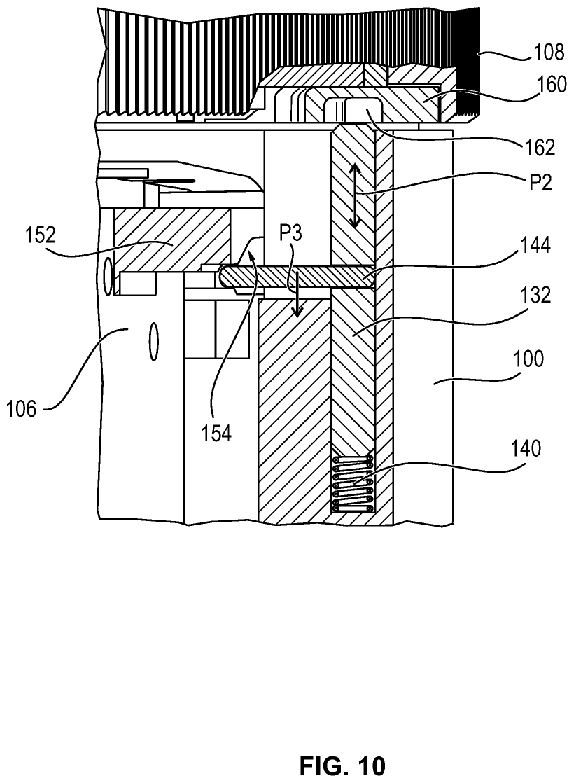

As shown in FIG. 10, pins 130 to 136 are each preloaded in the activated position via a spring 140.

Each of pins 130 to 136 is furthermore connected to a respective pin 142 to 148. As shown in FIG. 9, these pins 142 to 146 project into receiving region 102 and are each guided in an elongated hole of housing 100.

A movement of pins 142 to 148 allows pins 130 to 136 to be moved, against the return force of spring 140, from the activated into the deactivated position. Pins 142 to 148 must be moved for this purpose downward in the direction of arrow P3. In the depiction of FIG. 9, pins 144, 148 are moved downward against the return force of the respective spring so that, as shown in FIG. 8, the associated pins 132, 136 are correspondingly arranged in the deactivated position.

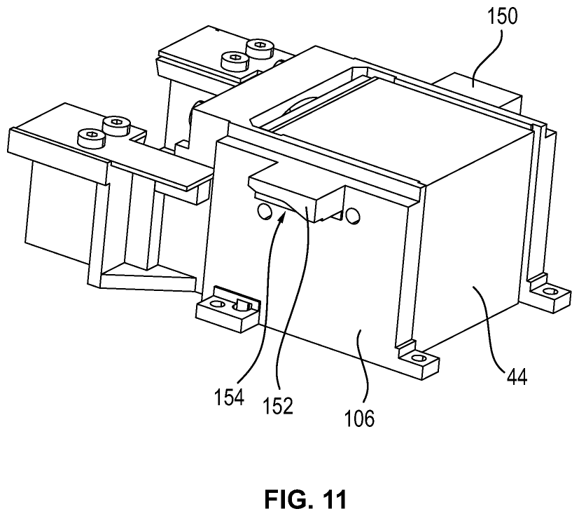

Pins 142, 148 are moved, with the aid of the respective objective 44 introduced into receiving region 102, by contact with the corresponding objective housing 106. FIG. 11 schematically depicts a portion of first objective 44. Two contact elements 150, 152 are provided on housing 106 of objective 44 on opposite sides of housing 102. The two contact elements 150, 152 each have a stepped contact surface 154. When objective 44 is slid into receiving region 102, pins 142 to 148 are then moved downward as shown in FIG. 10, provided the respective contact element 150, 152 comprises, in the region of the respective pin 142 to 148, a corresponding step on contact surface 154 which moves the corresponding pin 142 to 148 downward and holds it in that position. Pins 130 to 136 are correspondingly adjusted between the activated and deactivated position via pins 142 to 148.

Contact elements 150, 152 are configured differently depending on the objective 44, so that other pins 130 to 136 are arranged respectively in the activated or deactivated position.

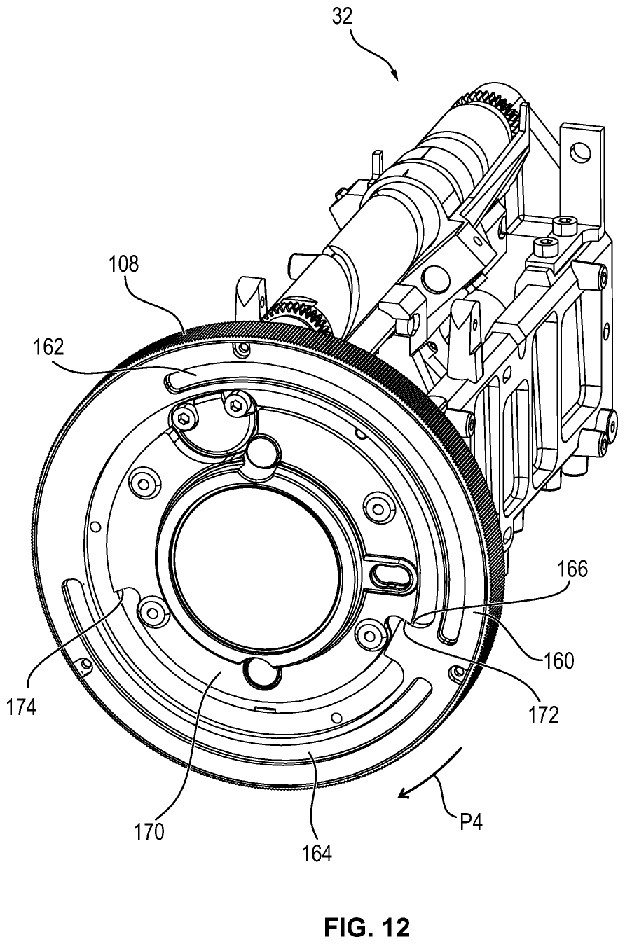

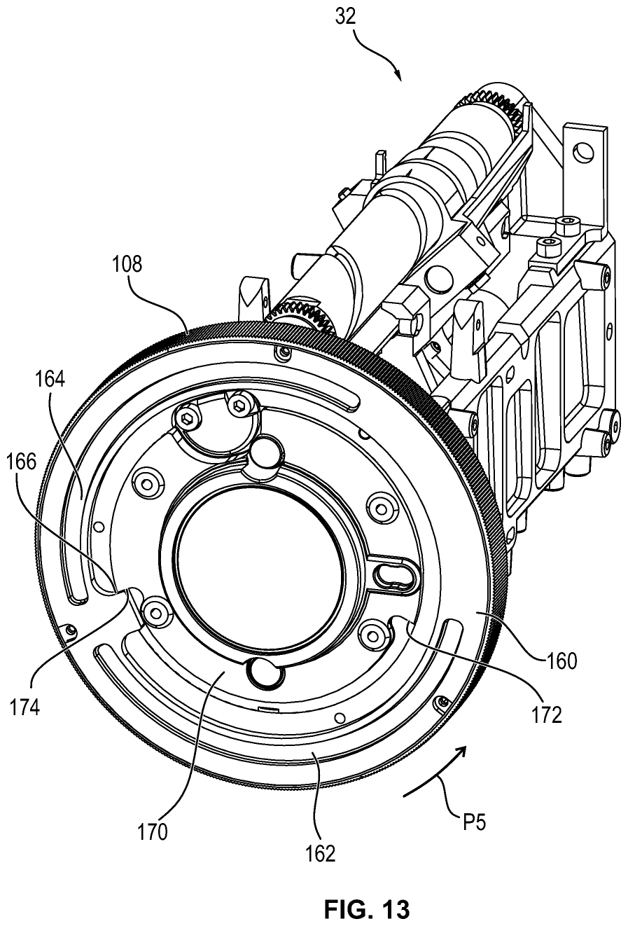

FIGS. 12 and 13 are respective perspective depictions of zoom system 32 depicting different rotational positions.

A gated disk 160 is arranged nonrotatably on rotary wheel 108 on the side facing toward objective system 30 and thus toward housing 100 of objective system 30. Two gates 162, 164 in the shape of circular segments, into which pins 130 to 136 can engage if they are respectively arranged in the activated position, are provided in this gated disk 160. Gated disk 160 furthermore comprises a protrusion 166 with which the rotatability of rotary wheel 108 is limited to a maximum rotation range. For that purpose, two stops 172, 174 are provided on a nonrotatable housing part 170 that is not rotated together with rotary wheel 108.

In the rotational position shown in FIG. 12, projection 166 abuts against first stop 172 so that the handwheel can be rotated only in the direction of arrow P4. This position is referred to in particular as the “0°” rotational position.

In FIG. 13, conversely, projection 166 abuts against second stop 174 so that the handwheel can be rotated only in the direction of arrow P5, that rotation direction P5 being opposite to rotation direction P4. In this second state, rotary wheel 108 is maximally rotated with respect to the 0° position shown in FIG. 12. This corresponds in particular to a rotation through an angle of 130°. The maximum rotation range of the handwheel is thus 130°. The total zoom range is predefined by this maximum rotation range.

Because of the arrangement of pins 130 to 136 in the activated position, and the engagement thereby produced into one of the two gates 162, 164, the rotatability of rotary wheel 108 can be limited depending on the objective 44 used, so that depending on the objective 44, handwheel 108 can be rotated only in a rotation sub-range that represents a sub-range of the maximum rotation range. The zoom sub-range is thus correspondingly set via these rotation sub-ranges, since a limitation of the rotation range of the handwheel automatically signifies a limitation of the available zoom range.

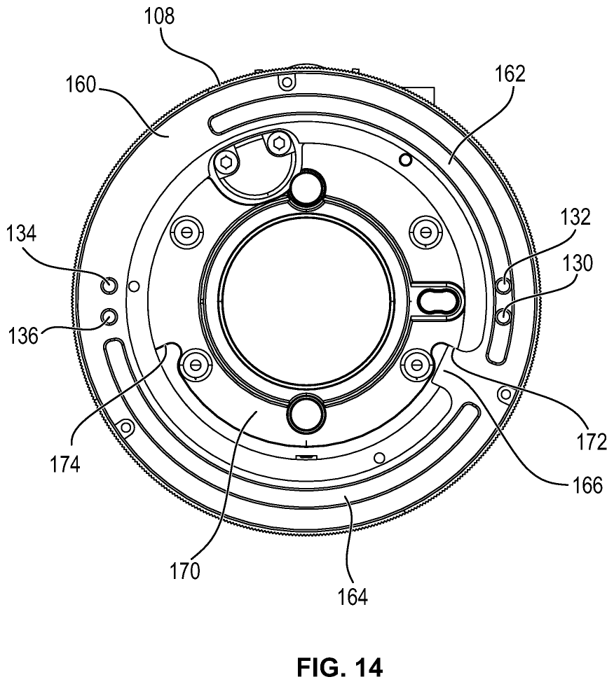

FIGS. 14 to 19 depict by way of example, for an objective system 30 having three different objectives, the manner in which a different rotation sub-range of rotary wheel 108 is defined for each of the three objectives by way of the different arrangement of pins 130, 132 in the respectively activated or deactivated position due to the differing configuration of contact elements 150, 152 of the various objectives, and thus a different zoom sub-range is allocated to the respective objective.

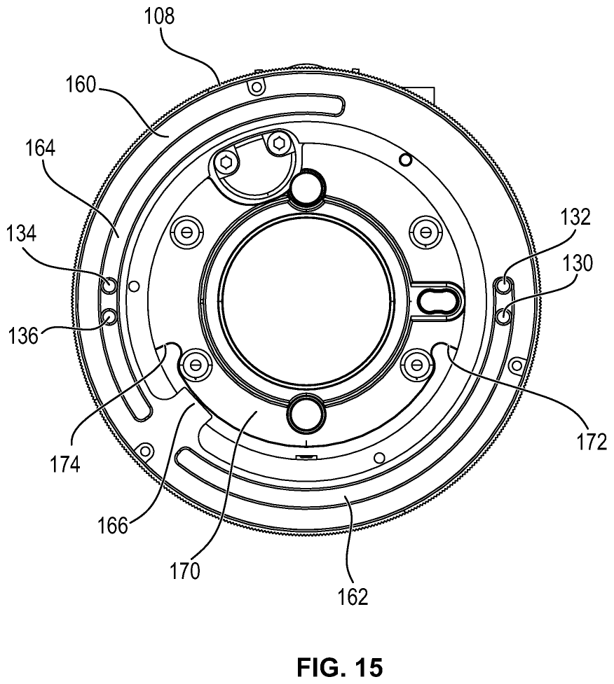

FIGS. 14 to 15 depict the situation that results when a first objective is introduced into receiving region 102, such that with this first objective, pin 132 is arranged in the activated position and pins 130 to 136 in the deactivated position. As shown in FIGS. 14 and 15, pin 132 thus engages into gate 162. Handwheel 108 can be rotated here between the 0° rotation position shown in FIG. 14 and the 112° rotation position shown in FIG. 15. A rotation beyond 112° is not possible, since pin 132 strikes against the end region of gate 162.

Alternatively, the other pins 130, 134, 136 could also be arranged in the activated position. In this case pins 134, 136 would firstly rest on the surface of gated disk 160 and would then, upon a slight rotation out of the 0° position, snap into gate 164. A movement back into the initial position would then not be possible.

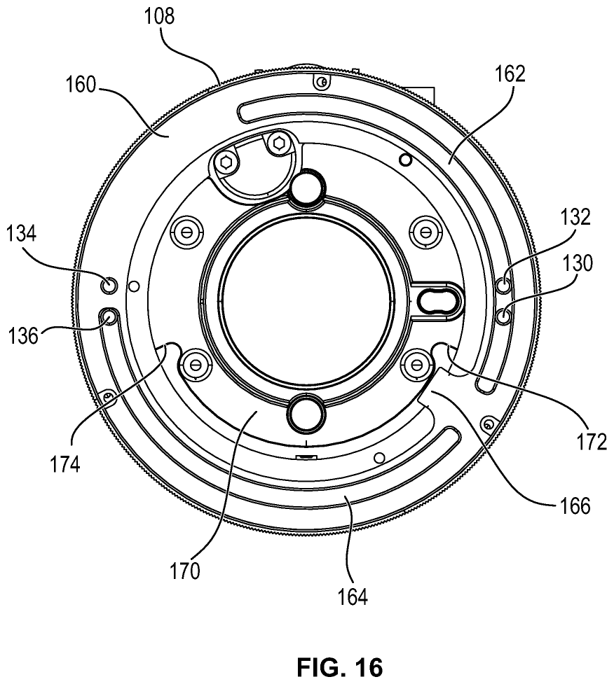

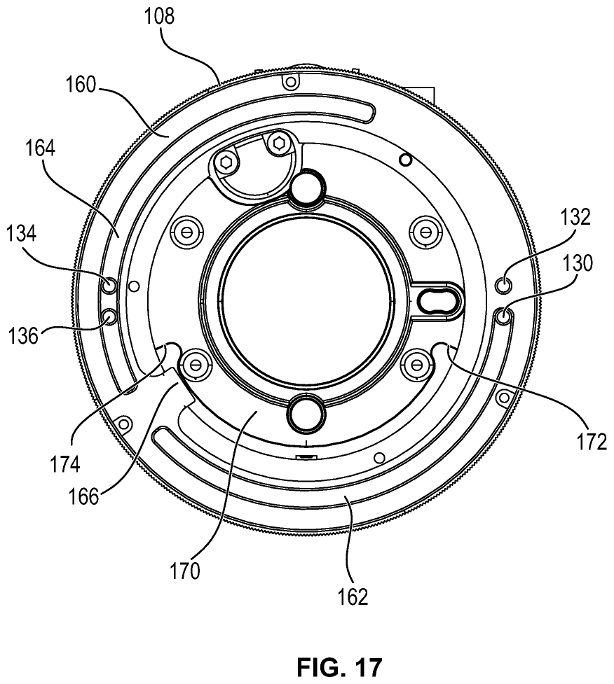

FIGS. 16 and 17 depict the situation that results when a second objective is introduced into receiving region 102 instead of the first objective; with this second objective, pins 130, 136 are arranged in the activated position and pins 132, 134 in the deactivated position. By way of the engagement of pin 136 into gate 164, the rotatability of rotary wheel 108 with the second objective is limited to a minimum rotation angle of 9°. Further rotation in direction P5, toward the 0° rotation position, is not possible.

Rotation in the opposite direction P4 is limited to a rotation angle of 121° by the engagement into gate 164 of pin 130, arranged in the activated position.

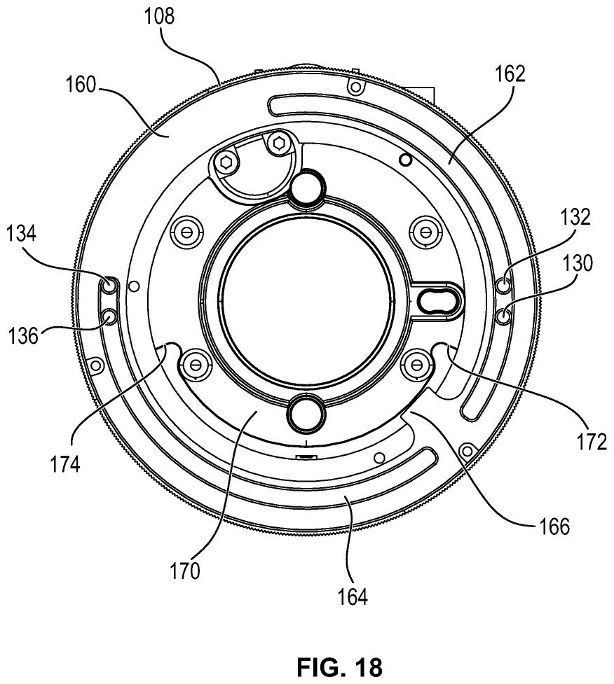

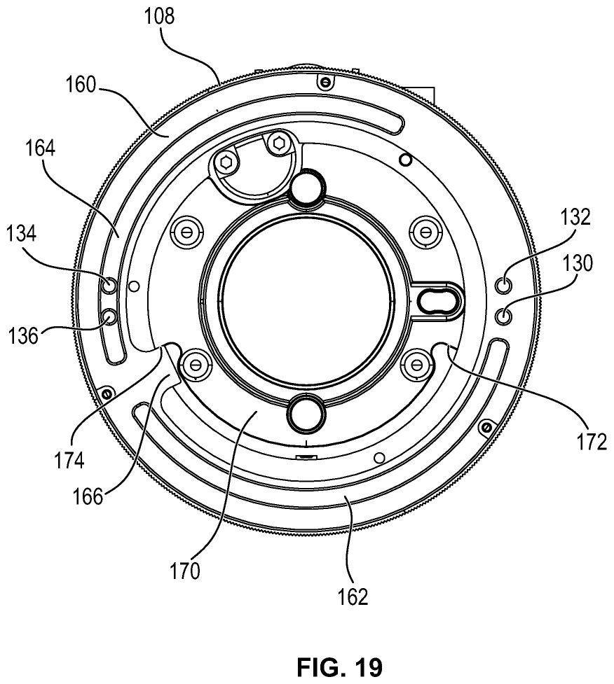

FIGS. 18 and 19 show the situation that results when a third objective is inserted into receiving region 102. With this third objective, contact elements 150 and 152 are embodied in such a way that pin 134 is arranged in the activated position and pins 130, 132, 134 are arranged in the deactivated position. Thanks to the engagement of pin 134 into gate 164, the rotatability of rotary wheel 108 in direction P5 is limited to 18° as a minimum rotation angle. In direction P4, conversely, rotary wheel 108 can be rotated until projection 166 strikes against second stop 174, i.e. to the maximum rotation angle of 130°.

As a result of the above-described arrangement with pins 130 to 136 that engage into the corresponding gates 162, 164, it is thus possible to limit the rotatability of rotary wheel 108 in simple fashion, entirely mechanically, depending on the objective 44, so that a zoom sub-range within the total zoom range can be allocated in simple and reliable fashion to each objective 44.

In an alternative embodiment, more or fewer than four pins 130 to 136 can also be provided. Alternatively, more or fewer than two gates 162, 164 can also be provided. The number of pins and gates can be adapted in particular to the number of different objectives used, and thus to the number of different zoom sub-ranges required.

### PARTS LIST

10 Microscope
12 Stand body
14 Pivoting unit
16 Housing
18 Specimen stage
20 Positioning wheel
30 Objective system
32 Zoom system
34, 36, 38 Lens group
40 Image capture unit
42 Field angle
44, 52 Objective
46, 48, 54, 56 Limiting element
50 Optical axis
90 Total zoom range
92 Lower limit
94 Upper limit
96, 98 Zoom sub-range
100 Housing
102 Receiving region
104 Plate
106 Objective housing
108 Rotary wheel
110 Knurling
112 Tooth set
114 Gear arrangement
116 Spindle
118, 120 Holding element
130 to 136 Pin
138 Surface
140 Spring
142, 148 Pin
150, 152 Contact element
154 Contact surface
160 Gated disk
162, 164 Gate
166 Projection
170 Housing part
172, 174 Stop
P1 to P5 Direction

1. A microscope (10), comprising:
an objective system (30) that has at least two objectives (44, 52) having different respective focal lengths, wherein a selected one of the at least two objectives (44, 52) is introducible into a beam path of the microscope; and
a zoom system (32) that has a total zoom range (90),
a respective total magnification of an object to be examined microscopically resulting respectively from the focal length of the selected objective (44, 52) and from a magnification of the zoom system (32) set within the total zoom range (90),
wherein a first zoom sub-range (96) within the total zoom range (90) is allocated to a first objective of the at least two objectives (44, 52) and a second zoom sub-range (98) is allocated to a second objective of the at least two objectives (44, 52),
wherein at least one of the first and second zoom sub-ranges (96, 98) is narrower than the total zoom range (90), and
wherein the microscope further comprises limiting means (46, 48, 54, 56) for limiting adjustability of the zoom system (32) to the zoom sub-range that is allocated to the selected objective (44, 52).

2. The microscope (10) according to claim 1, wherein each of the first and second zoom sub-ranges (96, 98) is narrower than the total zoom range (90), and the first zoom sub-range is different from the second zoom sub-range.

3. The microscope (10) according to claim 1, wherein a respective zoom sub-range is allocated to each of the at least two objectives (44, 52).

4. The microscope (10) according to claim 3, wherein the zoom sub-ranges (96, 98) of all the objectives (44, 52) are respectively narrower than the total zoom range (90).

5. The microscope (10) according to claim 2, wherein the first and second zoom sub-ranges (96, 98) at least partly overlap one another.

6. The microscope (10) according to claim 2, wherein the first zoom sub-range (96) has a zoom factor defined by a lower limit and an upper limit of the first zoom sub-range (96), the second zoom sub-range (98) has a zoom factor defined by a lower limit and an upper limit of the second zoom sub-range (98), and the zoom factor of the first zoom sub-range (96) is equal to the zoom factor of the second zoom sub-range (98).

7. The microscope (10) according to claim 2, wherein a lower limit of the first zoom sub-range (96) corresponds to a lower limit (92) of the total zoom range (90), and an upper limit of the second zoom sub-range (98) corresponds to an upper limit (94) of the total zoom range (90).

8. The microscope (10) according to claim 2, wherein the focal length of the first objective (44) is longer than the focal length of the second objective (52), wherein the first and second zoom sub-ranges (96, 98) are preset such that the first zoom sub-range (96) encompasses magnifications that are lower than a lowest magnification of the second zoom sub-range (98).

9. The microscope (10) according to claim 2, wherein the focal length of the second objective (52) is shorter than the focal length of the first objective (44), wherein the first and second zoom sub-ranges (96, 98) are preset such that the second zoom sub-range (98) encompasses magnifications that are higher than highest magnification of the first zoom sub-range (96).

10. The microscope (10) according to claim 1, wherein
the focal length of the second objective (52) is shorter than the focal length of the first objective (44);
a lower limit of the first zoom sub-range allocated to the first objective (44) corresponds to a lower limit of the total zoom range; and
an upper limit of the second zoom sub-range allocated to the second objective (52) corresponds to an upper limit of the total zoom range.

11. The microscope (10) according to claim 1, wherein the at least two objectives are embodied parfocally.

12. The microscope (10) according to claim 1, wherein at least one stop (46, 48, 54, 56) is provided as the limiting means on each of the first and second objectives (44, 52); and the adjustability of the zoom system (32) is limited by the at least one stop (46, 48, 54, 56) to the respective zoom sub-range (96, 98) of the selected objective (44, 52).

13. The microscope (10) according to claim 1, further comprising an electric drive unit for adjusting the zoom system (32), and a control unit for applying control to the drive unit; wherein the first and second zoom sub-ranges (96, 98) are stored in the control unit; and the control unit applies control to the drive unit such that an adjustment is possible in each case only within the respective zoom sub-range (96, 98) of the selected objective (44, 52).

14. The microscope (10) according to claim 1, further comprising a diaphragm for setting a light transmittance as a function of the selected objective (44, 52) and/or of the set magnification of the zoom system (32).

15. The microscope (10) according to claim 1, wherein the zoom system (32) comprises at least two lens groups (34 to 38), at least one of the at least two lens groups being movable along an optical axis (50) in order to set the magnification of the zoom system (32).

16. The microscope (10) according to claim 1, wherein the microscope (10) is a digital microscope that comprises an image capture unit (40) on which an image of the object to be examined microscopically is imageable with the aid of the zoom system (32).
